(19) United States
(12) Patent Application Publication
(10) Pub. No.: US 2010/0250227 A1
(43) Pub. Date: Sep. 30, 2010

(54) DETECTING AND CORRECTING OUT-OF-ORDER STATE ACCESSES USING DATA

(75) Inventors: Derek Chiou, Austin, TX (US); Hari Angepat, Austin, TX (US); Nikhil Patil, Austin, TX (US)

Correspondence Address: WINSTEAD PC, P.O. BOX 50784, DALLAS, TX, 75201, US

(73) Assignee: Board of Regents The University of Texas System, Austin, TX (US)

(21) Appl. No.: 12/749,595

(22) Filed: Mar. 30, 2010

Related U.S. Application Data
(60) Provisional application No. 61/164,961, filed on Mar. 31, 2009.

(51) Int. Cl. G06G 7/62

(52) U.S. Cl. 703/21

(57) ABSTRACT

A method, computer program product and system for detecting that a functional model execution is out-of-order with respect to a target execution. A value of a store instruction to be stored in a memory address, where the store instruction is executed by the functional model, is received by the timing model. This value is stored by the timing model in a target oracle memory at a time when the target system would execute the store instruction. The timing model compares the value in the target oracle memory with the value of a load instruction to be loaded from the same memory address, which is received from the functional model, at a time when the target system would execute the load instruction. The timing model detects an out-of-order instruction stream with respect to the target instruction stream if there is a miscomparison.

### CROSS-REFERENCE TO RELATED APPLICATIONS

This application is related to the following commonly owned co-pending U.S. patent application:

Provisional Application Ser. No. 61/164,961, “Detecting and Correcting State Access Reorderings Using Data,” filed Mar. 31, 2009, and claims the benefit of its earlier filing date under 35 U.S.C. §119(e).

### GOVERNMENT INTERESTS

The U.S. Government may own certain rights in this invention pursuant to the terms of the National Science Foundation Grant No. NSF-0615352 and pursuant to the terms of the Department of Energy Grant No. DOE-ER25686.

### TECHNICAL FIELD

The present invention relates to simulation, and more particularly to detecting and correcting an instruction stream executed by the functional model that is out-of-order with respect to the target instruction stream.

### BACKGROUND OF THE INVENTION

Simulation is one method to predict the behavior of a “target system” (the term “target” is used herein to refer to the system being simulated). A simulator mimics some or all of the behavior of the target system. Simulation is often used when measuring the target system itself is undesirable for a variety of reasons including target unavailability, target cost, or the inability to appropriately measure the target.

The behavior of computer systems is generally predicted using simulators. Most simulators of computers (referred to as “computer simulators”) are written entirely in software and executed on regular computers. Simulators can model computer system behavior at a variety of levels. For example, some simulators only model the instruction set architecture (ISA) and peripherals at a “functional” level, that is, at a detail level sufficient to implement functionality but not to predict timing. Such simulators are often able to boot operating systems and run unmodified applications and can be useful to provide visibility when debugging operating systems and software.

Other simulators model computer systems at a detail level sufficient to accurately predict the behavior of the computer system at a cycle-by-cycle level. Such simulators must accurately model all components that could potentially affect timing. They are often written by computer architects during the design of a computer system to help evaluate architectural mechanisms and determine their effect on overall performance.

However, these types of simulators are far too slow to run full operating systems and applications. As a result, a new type of simulator was developed in which the simulator was partitioned into a functional component (referred to as the “functional model”) and a timing component (referred to as the “timing model”). The functional model implements the functionality of the target system but does not predict behavior beyond the target system's functionality. The timing model predicts the behavior of the target system, such as the performance, power consumption, etc., using information from the functional model. Because the timing model does not implement any functionality and the functional model does not implement any timing prediction, the combination creates a complete simulator that is far simpler than the real target system. A more detail description of a simulator using the combination of a functional model and a timing model is disclosed in U.S. Patent Application Publication No. 2007/0150248, filed on Dec. 4, 2006, entitled “Simulation Method,” which is hereby incorporated herein by reference in its entirety.

In the case of a multiprocessor system, the execution order of the instruction stream (e.g., execution order of memory operations) by the functional model may be different than the execution order (e.g., execution order of memory operations) of the target system. For example, suppose that the target is a two core system. The functional model executes a load instruction to a particular memory address from the first core followed by a store instruction to the same memory address from the second core. Suppose further that the value at the memory address in question is originally 0. Hence, the functional model would indicate that the value of 0 is loaded as a result of the execution of the load instruction. However, suppose that the target system performs those two operations in the opposite order, with the second core first storing the logical value of “1,” then the first core loading from the same memory address. Hence, the logical value of 1 should be loaded as a result of the execution of the load execution. As a result, the target system loads a different value than the value indicated by the functional model resulting in inaccurate simulation.

Therefore, there is a need in the art for detecting an instruction stream executed by the functional model that is out-of-order with respect to the target instruction stream and for correcting the out-of-order instruction stream thereby generating the appropriate target-compatible instruction stream from the functional model.

### BRIEF SUMMARY OF THE INVENTION

In one embodiment of the present invention, a method for detecting that a functional model executed inconsistently with respect to a target system comprises generating a target value to be stored in a memory address. The method further comprises receiving a value used by the functional model. Additionally, the method comprises writing the target value into the memory address at a time the target system would have written the target value into the memory address. The method further comprises comparing the target value with the value used by the functional model at a time the target system would have used the target value. In addition, the method comprises detecting that an instruction stream executed by the functional model is inconsistent with respect to the target system if the target value in the memory address differs from the value used by the functional model.

In another embodiment of the present invention, a method for detecting that a functional model executed out-of-order with respect to a target system comprises receiving a value of a store instruction to be stored in a memory address where the store instruction is executed by the functional model. The method further comprises receiving a value of a load instruction to be loaded from the memory address where the load instruction is executed by the functional model. Additionally, the method comprises writing a value in a memory corresponding to the value to be stored by the executed store instruction at a time when the target system would execute the store instruction. Furthermore, the method comprises comparing the value in the memory with the value of the load instruction received from the functional model at a time when the target system would execute the load instruction. In addition, the method comprises detecting that an instruction stream executed by the functional model is out-of-order with respect to the target if the value in the memory differs with the value of the load instruction received from the functional model.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIG. 1 illustrates a hardware configuration of a computer system in accordance with an embodiment of the present invention;

FIG. 2 illustrates a partitioned simulator in accordance with an embodiment of the present invention; and

FIGS. 3A-B are a flowchart of a method for detecting that the functional model executed out-of-order with respect to a target instruction stream in accordance with an embodiment of the present invention.

### DETAILED DESCRIPTION OF THE INVENTION

The present invention comprises a method, computer program product and system for detecting and correcting when a particular execution order generated by one implementation is different than a modeled target system. The invention is useful for a wide range of applications, including building fast, accurate, parallelized computer simulators and building aggressive microprocessors that support multiple memory models.

In one embodiment of the present invention, a value of a store instruction to be stored in a memory address, where the store instruction is executed by the functional model, is received by the timing model. The value to be stored by the executed store instruction is stored by the timing model in a memory, referred to herein as the “target oracle memory,” or “TMO,” at a time when a target system would execute the store instruction. The value of a load instruction to be loaded from the memory address, where the load instruction is executed by the functional model, is received by the timing model. The timing model compares the value in the target oracle memory obtained at the time when the target system would have executed the load instruction with the value of the load instruction received from the functional model. The functional model memory operation execution is out-of-order with respect to the target memory operation execution if the value in the target oracle memory differs from the value of the load instruction received from the functional model.

While the following discusses the present invention in connection with memory operations being executed by the functional model in a different order than the target instruction stream, the principles of the present invention may be applied anywhere, and not just limited to instructions, the target system uses a different value than the functional model. For example, when modeling bit flips, due to reliability issues, in memory, registers, logic, or wires, the target system will use different values than the functional model. The same detection and correction scheme applies by comparing values. As another example, in a target that supports data speculation, the target system may use different load values than are stored in memory. The same detection and correction scheme applies to such systems as well. Embodiments covering such permutations would fall within the scope of the present invention. Furthermore, “memory operations,” discussed herein, are a proxy for any access of values and “out-of-order” is a proxy for any considered case where the functional value differs from the target value. Also, it is noted that the present invention automatically ignores when the execution order is different, but does not affect functionality, such as in the case when two load instructions get out of order but both still load the target value.

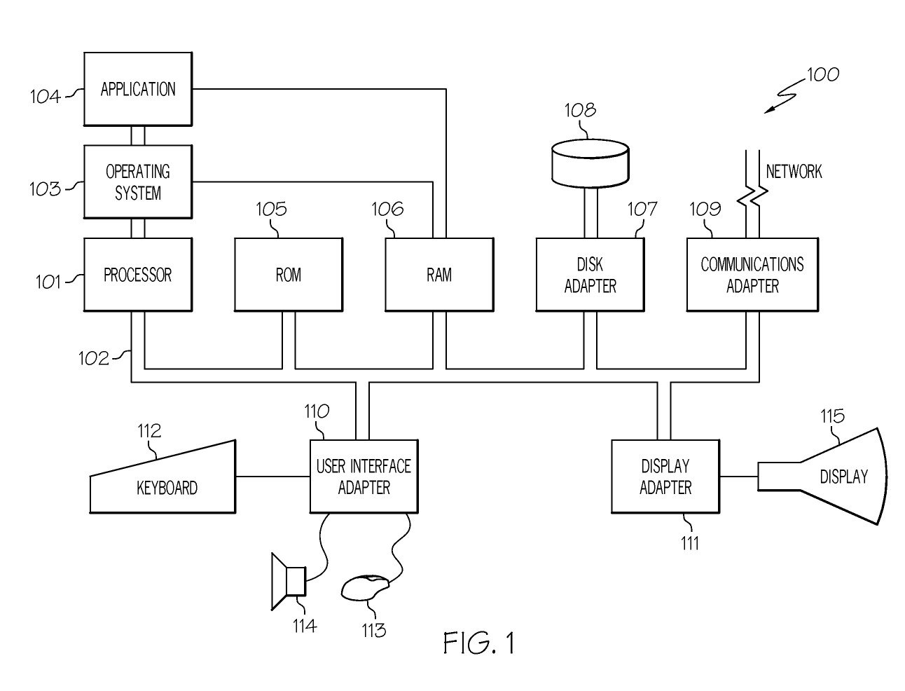

Referring to FIG. 1, FIG. 1 illustrates an embodiment of a hardware configuration of a computer system 100 which is representative of a hardware environment of the host or target for practicing the present invention. It is noted that the principles of the present invention may also be practiced using one or more field-programmable gate arrays.

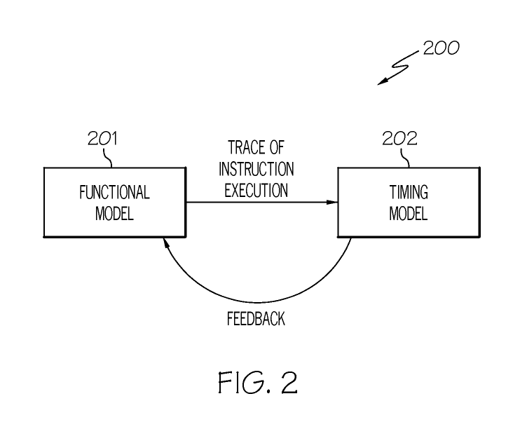

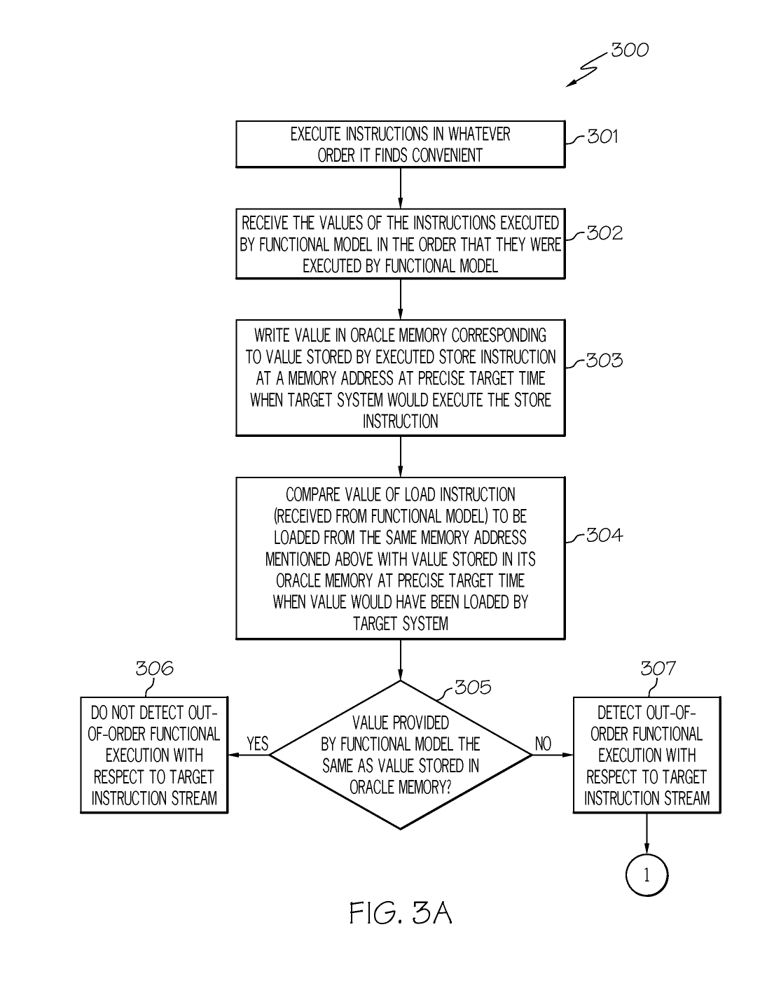

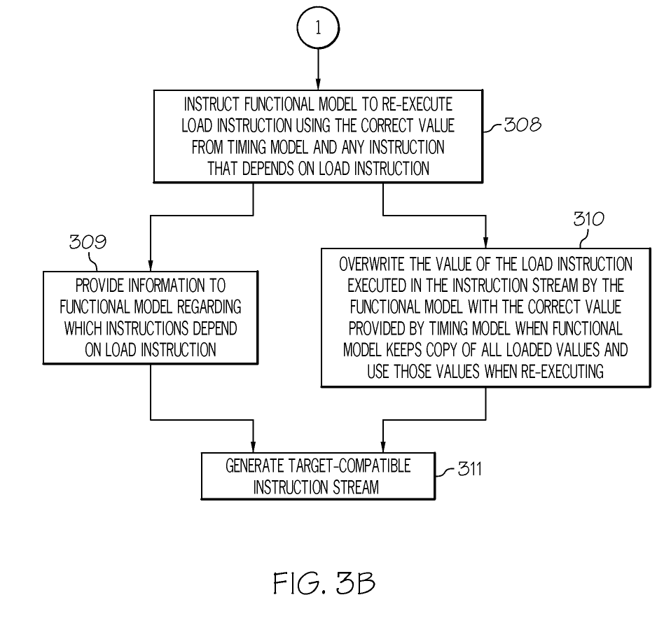

Turning now to FIG. 1, computer system 100 may have a processor 101 coupled to various other components by system bus 102. An operating system 103 may run on processor 101 and provide control and coordinate the functions of the various components of FIG. 1. An application 104 in accordance with the principles of the present invention may run in conjunction with operating system 103 and provide calls to operating system 103 where the calls implement the various functions or services to be performed by application 104. Application 104 may include, for example, a functional model (discussed further below in connection with FIG. 2), a timing model (discussed further below in connection with FIG. 2), and/or a program for detecting an instruction stream executed by a functional model that is out-of-order with respect to a target instruction stream, as discussed further below in connection with FIGS. 3A-B.

Referring to FIG. 1, read-only memory (“ROM”) 105 may be coupled to system bus 102 and include a basic input/output system (“BIOS”) that controls the code of certain basic functions of computer device 100. Random access memory (“RAM”) 106 and disk adapter 107 may also be coupled to system bus 102. It should be noted that software components including operating system 103 and application 104 may be loaded into RAM 106, which may be computer system's 100 main memory for execution. Disk adapter 107 may be an integrated drive electronics (“IDE”) adapter that communicates with a disk unit 108, e.g., disk drive.

Referring again to FIG. 1, computer system 100 may further include a communications adapter 109 coupled to bus 102. Communications adapter 109 may interconnect bus 102 with an outside network (not shown) thereby allowing computer system 100 to communicate with other similar devices.

I/O devices may also be connected to computer system 100 via a user interface adapter 110 and a display adapter 111. Keyboard 112, mouse 113 and speaker 114 may all be interconnected to bus 102 through user interface adapter 110. Data may be inputted to computer system 100 through any of these devices. A display monitor 115 may be connected to system bus 102 by display adapter 111. In this manner, a user is capable of inputting to computer system 100 through keyboard 112 or mouse 113 and receiving output from computer system 100 via display 115 or speaker 114.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As discussed in the Background section, in the case of a multiprocessor system, the execution order of the functional model (e.g., execution order of shared state operations, such as memory operations to shared memory locations) may be different than the execution order of the target system (e.g., execution order of shared stated operations, such as memory operations to shared memory locations). An instance where such a situation can occur is in the context of a simulator of a parallel computer system target that is run on a parallel host that may execute operations, such as memory operations to shared memory locations, in a potentially different order than the target system. Therefore, there is a need in the art for detecting that the functional model executes certain operations, such as memory operations to shared locations, out-of-order with respect to the target instruction stream and to provide sufficient information to allow the functional model to then execute instructions in the correct target order.

The principles of the present invention that detect when the functional model has executed out-of-order with respect to the target as well as enables the functional model to generate the appropriate target-compatible instruction stream is discussed below in connection with FIGS. 2 and 3A-B. FIG. 2 depicts a partitioned simulator implementing the principles of the present invention. FIGS. 3A-B are a flowchart of a method for detecting an instruction stream executed by a functional model that is out-of-order with respect to a target instruction stream.

Referring to FIG. 2, FIG. 2 illustrates a partitioned simulator 200 in accordance with an embodiment of the present invention. Partitioned simulator 200 includes a functional model 201 and a timing model 202. Functional model 201 may be implemented in software or hardware. Furthermore, timing model 202 may be implemented in software or hardware. To be clear, functional model 201 and timing model 202 do not have to be implemented in the same manner. For example, functional model 201 may be implemented in software and timing model 202 may be implemented in hardware.

Functional model 201 implements the functionality of the target system. Timing model 202, however, predicts target behavior, such as target performance or target power consumption by the target system. That is, timing model 202 focuses on the movement of control and data through the target at timing resolution up to, and including, cycle-by-cycle aspects or focuses on the movement of the instructions through the target system. In one embodiment, as functional model 201 executes in its own order (referred to as the “functional instruction path” or “functional path”), it generates an instruction trace comprised of trace entries in the order in which instructions were executed by the functional model, where each trace entry corresponds to each executed instruction and provides information (e.g., opcode executed, the source and destination registers, the physical and virtual memory addresses of the instruction and the data (if any)) that is transmitted to timing model 202. The instruction trace may be used by timing model 202 to determine if functional model 201 executed out-of-order with respect to the target instruction stream as discussed below in connection with FIGS. 3A-B.

FIGS. 3A-B are a flowchart of a method 300 for detecting that functional model 201 (FIG. 2) executed out-of-order with respect to a target instruction stream in accordance with an embodiment of the present invention.

Referring to FIG. 3A, in conjunction with FIGS. 1 and 2, in step 301, functional model 201 executes instructions in an instruction stream in whatever order it finds convenient, such as program order.

In step 302, timing model 202 receives the values of the instructions executed by functional model 201 in the order that they were executed by functional model 201. For example, functional model 201 provides an instruction trace which includes the values of the executed instructions, such as the value loaded by the load instruction or the value stored by the store instruction. It is noted that if functional model 201 is modeling a multicore target, it can generate multiple instruction traces, one per core in the target. Each separate instruction trace per target core might only contain the values of the loads and stores originating from that target core and do not have to be ordered relative to each other.

In step 303, timing model 202 writes a value in a memory, referred to herein as the “target oracle memory,” that corresponds to the value stored by the executed store instruction at a memory address at the precise target time when the target system would execute the store instruction. For example, suppose that the store instruction in question is to store a logical value of “1” at a particular memory address. The logical value of “1” may then be written by timing model 202 in the target oracle memory at the precise target time when the target system would execute that store instruction. The initial values in the target oracle memory should be identical to the initial values in the functional memory.

In one embodiment, the target oracle memory may reside as a portion of random access memory (e.g., RAM 106). In other embodiments, the target oracle memory may reside in a flash memory or a disk unit (e.g., disk drive 108).

In step 304, timing model 202 compares the value of a load instruction (received from functional model 201 in step 302) to be loaded from the same memory address mentioned above with the value stored in its target oracle memory at the precise target time when the value would have been loaded by the target system. For example, suppose timing model 202 receives the value of 0 as the value loaded by the load instruction by functional model 201. This value of 0 is then compared with the value stored in its target oracle memory at the precise target time when the value would have been loaded by the target system (i.e., when the target system would have executed this load instruction).

In step 305, timing model 202 determines if the value provided by functional model 201 is the same as the value stored in its target oracle memory at the precise target time when the value would have been loaded by the target system.

If there is not a difference between the value of the load instruction received from functional model 201 in step 302 with the value stored in its target oracle memory at the precise target time when the value would have been loaded by the target system, then, in step 306, for that load, functional model 201 has executed in a manner consistent with target execution.

However, if there is a difference between the value of the load instruction received from functional model 201 in step 302 with the value stored in its target oracle memory at the precise target time when the value would have been loaded by the target system, then, in step 307, timing model 202 detects that functional model 201 executed in an order inconsistent with the target.

Referring to FIG. 3B, in conjunction with FIGS. 1 and 2, in step 308, timing model 202 instructs functional model 201 to re-execute the load instruction using the correct value from timing model 202 and to re-execute any instruction that depends on the load instruction. For instance, referring to the previously discussed example, the value of “0” loaded by the load instruction by functional model 201 is replaced with the correct value of logical “1.”

In connection with determining data dependencies from the value of the load instruction to be corrected, in step 309, timing model 202 provides the information regarding which instructions depend on the load instruction to functional model 201. In one embodiment, timing model 202 includes the capability of detecting which instructions depend on the corrected load.

Alternatively, in step 310, functional model 201 overwrites the value of the load instruction with the correct value provided by timing model 202 when functional model 201 keeps a copy of all the loaded values for all uncommitted instructions. For instance, functional model 201 may store a copy of all the loaded values for all uncommitted instructions in a memory buffer (e.g., memory buffer may be contained in memory 106). Functional model 201 may then replace the incorrect value with the correct value for the particular load instruction in question in the memory buffer and then re-execute starting from the particular load instruction in question. All re-executed instructions, including ones that were not dependent on the particular load instruction in question, use the values found in the memory buffer.

In step 311, upon re-executing the load instruction and any instruction that follows it that was executed along with the load instruction in the first execution, functional model 201 generates a target-compatible instruction stream.

Method 300 may include other and/or additional steps that, for clarity, are not depicted. Further, method 300 may be executed in a different order presented and the order presented in the discussion of FIGS. 3A-B is illustrative. Additionally, certain steps in method 300 may be executed in a substantially simultaneous manner or may be omitted.

Though the present invention was described in the context of a simulator, it is applicable for any system where one system potentially executes in a different order than is desired. For example, one could use the present invention to provide a variety of memory models by modeling the target oracle memory for a system that supports the desired memory model and using it to correct the functional model that could be implemented by an out-of-order processor itself. Thus, the principles of the present invention could be used to provide a configurable memory system, supporting multiple memory models, to computer systems.

Although the method, computer program product and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for detecting that a functional model executed inconsistently with respect to a target system, the method comprising:
generating a target value to be stored in a memory address;
receiving a value used by said functional model;
writing said target value into said memory address at a time said target system would have written said target value into said memory address;
comparing said target value with said value used by said functional model at a time said target system would have used said target value; and
detecting that an instruction stream executed by said functional model is inconsistent with respect to said target system if said target value in said memory address differs from said value used by said functional model.

2. The method as recited in claim 2 further comprising:
correcting said value used by the functional model; and
re-executing said corrected value.

3. A computer program product embodied in a computer readable storage medium detecting that a functional model executed inconsistently with respect to a target system, the computer program product comprising the programming instructions for:
generating a target value to be stored in a memory address;
receiving a value used by said functional model;
writing said target value into said memory address at a time said target system would have written said target value into said memory address;
comparing said target value with said value used by said functional model at a time said target system would have used said target value; and
detecting that an instruction stream executed by said functional model is inconsistent with respect to said target system if said target value in said memory address differs from said value used by said functional model.

4. The computer program product as recited in claim 3 further comprising the programming instructions for:
correcting said value used by the functional model; and
re-executing said corrected value.

5. A system, comprising:
a memory unit for storing a computer program for detecting that a functional model executed inconsistently with respect to a target system; and
a processor coupled to said memory unit, wherein said processor, responsive to said computer program, comprises:
circuitry for generating a target value to be stored in a memory address;
circuitry for receiving a value used by said functional model;
circuitry for writing said target value into said memory address at a time said target system would have written said target value into said memory address;
circuitry for comparing said target value with said value used by said functional model at a time said target system would have used said target value; and
circuitry for detecting that an instruction stream executed by said functional model is inconsistent with respect to said target system if said target value in said memory address differs from said value used by said functional model.

6. The system as recited in claim 5, wherein said processor further comprises:
circuitry for correcting said value used by the functional model; and
circuitry for re-executing said corrected value.

7. A method for detecting that a functional model executed out-of-order with respect to a target system, the method comprising:
receiving a value of a store instruction to be stored in a memory address where said store instruction is executed by said functional model;
receiving a value of a load instruction to be loaded from said memory address where said load instruction is executed by said functional model;
writing a value in a memory corresponding to said value to be stored by said executed store instruction at a time when said target system would execute said store instruction;
comparing said value in said memory with said value of said load instruction received from said functional model at a time when said target system would execute said load instruction; and
detecting that an instruction stream executed by said functional model is out-of-order with respect to said target system if said value in said memory differs with said value of said load instruction received from said functional model.

8. The method as recited in claim 7 further comprising:
instructing said functional model to re-execute said load instruction using said value in said memory and to re-execute any instruction that depends on said load instruction.

9. The method as recited in claim 8 further comprising:
providing information to said functional model regarding which instructions depend on said load instruction.

10. The method as recited in claim 8 further comprising:
overwriting said value of said load instruction executed in said instruction stream by said functional model with said value in said memory when said functional model keeps a copy of all loaded values for all uncommitted instructions.

11. The method as recited in claim 8 further comprising:
generating a target-compatible instruction stream upon said re-execution of said load instruction and any instruction that depends on said load instruction.

12. A computer program product embodied in a computer readable storage medium for detecting that a functional model executed out-of-order with respect to a target system, the computer program product comprising the programming instructions for:
receiving a value of a store instruction to be stored in a memory address where said store instruction is executed by said functional model;
receiving a value of a load instruction to be loaded from said memory address where said load instruction is executed by said functional model;
writing a value in a memory corresponding to said value to be stored by said executed store instruction at a time when said target system would execute said store instruction;
comparing said value in said memory with said value of said load instruction received from said functional model at a time when said target system would execute said load instruction; and
detecting that an instruction stream executed by said functional model is out-of-order with respect to said target system if said value in said memory differs with said value of said load instruction received from said functional model.

13. The computer program product as recited in claim 12 further comprising the programming instructions for:
instructing said functional model to re-execute said load instruction using said value in said memory and to re-execute any instruction that depends on said load instruction.

14. The computer program product as recited in claim 13 further comprising the programming instructions for:
providing information to said functional model regarding which instructions depend on said load instruction.

15. The computer program product as recited in claim 13 further comprising the programming instructions for:
overwriting said value of said load instruction executed in said instruction stream by said functional model with said value in said memory when said functional model keeps a copy of all loaded values for all uncommitted instructions.

16. The computer program product as recited in claim 13 further comprising the programming instructions for:
generating a target-compatible instruction stream upon said re-execution of said load instruction and any instruction that depends on said load instruction.

17. A system, comprising:
a memory unit for storing a computer program for detecting that a functional model executed out-of-order with respect to a target system; and
a processor coupled to said memory unit, wherein said processor, responsive to said computer program, comprises:
circuitry for receiving a value of a store instruction to be stored in a memory address where said store instruction is executed by said functional model;
circuitry for receiving a value of a load instruction to be loaded from said memory address where said load instruction is executed by said functional model;
circuitry for writing a value in a memory corresponding to said value to be stored by said executed store instruction at a time when said target system would execute said store instruction;
circuitry for comparing said value in said memory with said value of said load instruction received from said functional model at a time when said target system would execute said load instruction; and
circuitry for detecting that an instruction stream executed by said functional model is out-of-order with respect to said target system if said value in said memory differs with said value of said load instruction received from said functional model.

18. The system as recited in claim 17, wherein said processor further comprises:
circuitry for instructing said functional model to re-execute said load instruction using said value in said memory and to re-execute any instruction that depends on said load instruction.

19. The system as recited in claim 18, wherein said processor further comprises:
circuitry for providing information to said functional model regarding which instructions depend on said load instruction.

20. The system as recited in claim 18, where said processor further comprises:
circuitry for overwriting said value of said load instruction executed in said instruction stream by said functional model with said value in said memory when said functional model keeps a copy of all loaded values for all uncommitted instructions.

21. The system as recited in claim 18, wherein said processor further comprises:
circuitry for generating a target-compatible instruction stream upon said re-execution of said load instruction and any instruction that depends on said load instruction.
